(19) United States
(12) Patent Application Publication
(10) Pub. No.: US 2017/0082319 A1
(43) Pub. Date: Mar. 23, 2017

(54) HYDRONIC SPACE HEATING SYSTEM HAVING TWO STAGE HEAT PUMP BUFFER TANK

(71) Applicant: AMTROL Licensing Inc., West Warwick, RI (US)

(72) Inventor: Roger Manser, Uxbridge, MA (US)

(73) Assignee: AMTROL Licensing Inc., West Warwick, RI (US)

(21) Appl. No.: 14/857,945

(22) Filed: Sep. 18, 2015

(51) Int. Cl. F24H 6/00; F24H 4/00; H05B 3/00; F24H 1/00; H05B 1/02; F24H 1/50; F24H 8/00

(52) U.S. Cl. CPC F24H 6/00; F24H 1/50; F24H 4/00; F24H 8/00; F24H 1/0018; H05B 1/0283; H05B 3/0014

(57) ABSTRACT

A hydronic space heating system including a buffer tank defining upper and lower chambers in fluid and thermal communication with one another, the upper and lower chambers being separated by a baffle having passages formed therein to allow fluid flow from the lower chamber to the upper chamber to facilitate heat transfer therebetween in a controlled manner, a heat pump associated with the lower chamber of the buffer tank and having an output for heating water in the lower chamber of the buffer tank to a temperature within a predefined temperature range, and an auxiliary heat source associated with the upper chamber of the buffer tank having an output for increasing the temperature of water in the upper chamber of the buffer tank to conditionally supplement the output of the heat pump.

### BACKGROUND OF THE INVENTION

1. Field of the Invention

The subject invention relates to a space heating system, and more particularly, to a hydronic space heating system that includes a two stage heat pump buffer tank for improving the thermodynamic efficiency and coefficient of performance of the heating system.

2. Description of Related Art

In most regions of North America, space heating of buildings is a necessity for some portion of the year to maintain thermal comfort. Buildings are space-heated in a variety of ways. One way is by forced hot water or hydronic heating, which uses a pump to circulate water in a closed system through a boiler for heating to a variety of space heating devices or emitters such as baseboard fin-tube radiators, radiant panels, and radiant floor heating tubing. Another way of space heating is by forced air heating using a fan coil emitter.

A majority of the boilers that are used to heat water in a hydronic space heating system are warmed directly by hot gases produced by a fossil fuel burner. It is also known to use an air source heat pump (ASHP) for heating water in a hydronic space heating system.

An ASHP is a system which transfers heat from outside of a building to the inside of the building, or vice versa. Under the principles of vapor compression refrigeration, an ASHP uses a refrigerant system involving a compressor and a condenser to absorb heat at one place and release it at another. They can be used as a space heater or cooler.

In domestic heating use, an ASHP absorbs heat from outside air and releases it inside the building, as hot air, hot water-filled radiators, underfloor heating and/or domestic hot water supply. The same system can often do the reverse in summer, cooling the inside of the house. When correctly specified, an ASHP can offer a full central heating solution and domestic hot water up to 80 degrees C. or more.

Modern building codes are continually improving the thermal performance of buildings. As the thermal envelope of the building improves the ratio of Potable Water Heating (PWH) to Space Heating (HW) increases. Indeed, in a modern high performance building it is not uncommon for the PWH requirement to be greater than the SH requirement. This presents an opportunity for the greater acceptance of heat pump systems including air, water and ground sourced systems to be used for both potable water heating and space heating.

### SUMMARY OF THE INVENTION

The subject invention is directed to a new and useful hydronic space heating system for a building that includes a buffer tank defining upper and lower chambers in fluid and thermal communication with one another. The upper and lower chambers are separated from each other by a baffle having passages formed therein to allow fluid flow from the lower chamber to the upper chamber in a controlled manner to facilitate heat transfer.

An air sourced heat pump is operatively associated with the lower chamber of the buffer tank. The air sourced heat pump has an output for heating water in the lower chamber of the buffer tank to a temperature within a predefined temperature range.

In addition, to the heat pump, an auxiliary heat source is operatively associated with the upper chamber of the buffer tank. The auxiliary heat source has an output for increasing the temperature of water in the upper chamber of the buffer tank to conditionally supplement the output of the heat pump.

The system further includes at least one emitter for heating an interior space of the building. The at least one emitter may be selected from a group of emitters that includes, for example, baseboard fin-tube radiators, radiant panels, radiant floor heating tubing, and fan coil air handlers. The system also includes an in-line fluid pump for circulating heated water through the system. Preferably, the in-line fluid pump is located between the upper chamber of the buffer tank and the at least one emitter. However, the circulation pump could be associated with the supply side or the return side of the at least one emitter.

The lower chamber of the buffer tank is heated by the heat pump to a range of about between 80-140 degrees F. The auxiliary heat source is adapted to increase the temperature of water in the upper chamber of the buffer tank to a temperature of about between 140-180 degrees F.

Preferably, the output of the heat pump is transferred to the lower chamber of the buffer tank by an internal heating coil located within the lower chamber of the buffer tank. Alternatively, the output of the heat pump is transferred to the lower chamber of the buffer tank by an external heating coil wrapped around the lower chamber of the buffer tank. It is also envisioned that the output of the heat pump could be transferred to the lower chamber of the buffer tank by a heat exchanger.

The upper chamber of the buffer tank is heated by an auxiliary heat source. Preferably, the output of the auxiliary heat source is provided for example, by oil, natural gas or propane, or by an electric resistance element.

These and other features of the hydronic space heating system of the subject invention and the manner in which it is manufactured and employed will become more readily apparent to those having ordinary skill in the art from the following enabling description of the preferred embodiments of the subject invention taken in conjunction with the several drawings described below.

### BRIEF DESCRIPTION OF THE DRAWINGS

So that those skilled in the art to which the subject invention appertains will readily understand how to make and use the subject invention without undue experimentation, preferred embodiments thereof will be described in detail herein below with reference to certain FIGURES, wherein:

FIG. 1 is a schematic rendering of the hydronic space heating system of the subject invention, which includes a two stage heat pump buffer tank for improving the efficiency of the system.

### DETAILED DESCRIPTION OF PREFERRED EMBODIMENTS

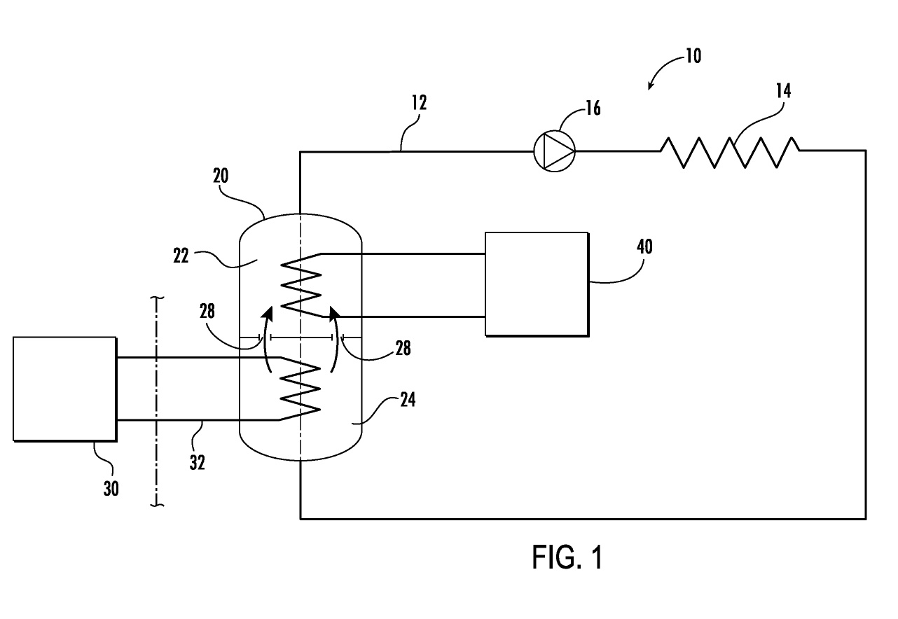

Referring now to the drawings, wherein like reference numerals identify similar structural features or aspects of a system, there is illustrated in FIG. 1 a schematic rendering of a hydronic space heating system constructed in accordance with a preferred embodiment of the subject invention and designated generally by reference numeral 10. The hydronic space heating system 10 of the subject invention is adapted and configured to improve the thermal performance of a building, such as for example, a modern residential or commercial building space.

Referring to FIG. 1, space heating system 10 includes a hydronic water circuit 12 consisting of piping or conduit for facilitating the circulation of heated water through the system 10. A buffer tank 20 is located within the hydronic water circuit 12, along with at least one emitter 14 for radiant heating and an in-line pump 16 for circulating heated water through the circuit 12. These system components will be discussed in greater detail below.

The buffer tank 20 has a capacity of about between 20 to 120 gallons, and it defines an upper chamber 22 and a lower chamber 24 depending upon building demand. The upper and lower chamber 22 and 24 are in fluid communication with one another.

The upper and lower chambers 22 and 24 of buffer tank 20 are physically separated from each other by a baffle 26. The baffle 26 has a plurality of passages 28 formed therein to allow fluid flow from the lower chamber 24 to the upper chamber 22 in a controlled manner. The geometry, size and/or number of passages in the baffle 26 can vary depending upon the amount of fluid exchange that is desired to achieve the necessary fluid flow and maintain thermal isolation between the two chambers of the buffer tank 20.

An air sourced heat pump (ASHP) 30 is operatively associated with the lower chamber 24 of the buffer tank 20. The air sourced heat pump 30 is located outside of the building being heated. It has an output for heating water in the lower chamber 24 of the buffer tank 20 to a temperature within a predefined temperature range.

Preferably, the output of the ASHP 30 is set to heat water in the lower chamber 24 of buffer tank 20 to a Reset Temperature (T_{R}) in the range of about between 80-140 degrees F. This Reset Temperature will depend upon the specifications of the heat pump, the type of refrigerant used with the heat pump, the overall design of the heating system, and primarily the heat demand of the building and the design of the emitters.

In accordance with the subject invention, the output of the heat pump 30 is transferred to the lower chamber 24 of the buffer tank 20 by an internal heating coil 32 located within the lower chamber 24 of the buffer tank 20, as shown in FIG. 1. Alternatively, the output of the heat pump 30 may be transferred to the lower chamber 24 of the buffer tank 20 by an external heating coil wrapped around the lower chamber 24 of the buffer tank 20. It is also envisioned that the output of the heat pump 30 could be transferred to the lower chamber 24 of the buffer tank 20 by a heat exchanger or the like.

In addition to the heat pump 30, the system 10 includes an auxiliary heat source 40 located within the building being heated and operatively associated with the upper chamber 22 of the buffer tank 20. The auxiliary heat source 40 is essentially a water boiler that has an output communicating with the interior of the upper chamber 22 of the buffer tank 20 for increasing the temperature of water in the upper chamber 22 of the buffer tank 20 to conditionally supplement the output of the heat pump 30 under certain conditions.

More particularly, the auxiliary heat source 40 is adapted to increase the temperature of water in the upper chamber 22 of the buffer tank 20 to a temperature of about between 140 to 180 degrees F. Preferably, the output of the auxiliary heat source 40 is provided for example, by an oil burner or by an electric resistance element.

As described above, the system 10 further includes at least one emitter 14 for heating an interior space of the building. The at least one emitter 14 may be selected from a group of emitters that includes, for example, baseboard fin-tube radiators, radiant panels, and radiant floor heating tubing. Fan cell air handlers may also be utilized.

As mentioned, the system 10 also includes an in-line fluid pump 16 for circulating heated water through the circuit 12. Preferably, the in-line fluid pump 16 is located between the upper chamber 22 of the buffer tank 20 and the at least one emitter 14. However, the circulation pump 16 could be located on either the supply side or the return side of the at least one emitter 14. Other types of fluid circulation pumps could also be employed. The capacity of the circulation pump that is employed will vary depending upon the size of the circuit 12 and the volume of fluid being pumped therethrough.

In operation, the upper chamber (or high temperature chamber) 22 of buffer tank 20 will be heated by the lower chamber 24 of buffer tank 20 through heat transfer with the lower chamber 24, and by the flow of fluid from the lower chamber 24 to the upper chamber 22 through the passages 28 in the baffle 26 as the in-line pump 16 circulates heating water through the hydronic circuit 12. During moderate degree days, the heat pump 30 and the lower chamber 24 will provide sufficient heat output and water temperature to meet building demand.

On extremely cold days, it may be desirable to use the auxiliary heat source 40 to increase the temperature of the water in the upper chamber 22 of the buffer tank 20. This will allow the heat emitter(s) 16 to have a higher heat output, as required, to meet the building load. The main advantage of this system is that the heat pump 30 can reject heat into the buffer tank 20 at a lower temperature, for example, in the range of 80-140 degrees F., thereby increasing the thermodynamic efficiency and coefficient of performance (COP) of the system.

It is envisioned that the heat pump 30 could be sized to handle all or a percentage of the heating days. When the outside temperature is extremely cold, the auxiliary heat source 40 could be used to supplement the output of the heat pump 30. This will allow the full output of the heat pump 30 to be used for the entire heating season. Thus, fossil fuels and the auxiliary heat source 40 will be used only as required on the coldest heating days.

This may be particularly attractive for retrofit applications that use conventional high temperature, i.e., 140-180 degrees F. baseboard emitters. Under moderate heating conditions the buffer tank 20 will be reset to a lower temperature so that the heat output of the emitters closely matches the building load at 100% duty cycle. During extremely cold days where high temperature water, i.e., 140-180 degrees F., must be supplied to the emitters in order to meet the building load, the temperature of the upper high temperature chamber 22 of buffer tank 20 will be increased to 140-180 degrees F. by the auxiliary heat source 40.

In operation, hydronic system water is pumped through the emitter(s) 16 where the building cools the water. It is then returned to the lower chamber 24 of buffer tank 20, where the heat pump 30 heats the water to a temperature for optimum heat pump performance and efficiency. The water in the lower chamber 24 then transfers heat to the upper chamber 22 by conduction and/or convection, and fluid flow from the lower chamber 24 to the upper chamber 22 as the system circulates. As required, the auxiliary heat source 40 may be used to further increase the temperature of the water in the upper chamber 22. The hydronic system water is then pumped from the upper chamber 22 through the circuit 12 and emitter(s) 16, returning to the lower chamber 24.

Keeping the upper chamber 22 of buffer tank 20 as close to the minimum temperature required by the base board emitter 16, for a 100% duty cycle, allows the lower buffer tank chamber 24 and heat pump 30 to supply the largest percentage of heat possible, for optimum heat pump performance, and system efficiency.

In this manner a conventional hydronic heat system designed with high temperature emitters can be effectively used for a heat pump system. Axillary fossil fuel based energy will only be used a supplemental heat source on the coldest days of the heating season, greatly reducing fossil fuel usage, and optimizing the systems efficiency. The two stage buffer tank 20 can also be applied to modern low temperature emitter hydronic systems in a similar manner.

It is envisioned that a coil to preheat potable water can also be incorporated into the buffer tank 20. This coil would preheat the incoming potable water to the buffer tank reset temperature (T_{R}). The output of the coil would then be feed into a conventional direct or indirect fired water heater to be heated to the final point of use temperature. This allows the heat pump to provide a large percentage of the PWH heating requirement.

While the subject invention has been shown and described with reference to preferred embodiments, those skilled in the art will readily appreciate that various changes and/or modifications may be made thereto without departing from the spirit and scope of the subject invention as defined by the appended claims.

What is claimed is:

1. A hydronic space heating system comprising:
a) a buffer tank defining upper and lower chambers in fluid and thermal communication with one another, the upper and lower chambers being separated by a baffle having passages formed therein to allow fluid flow from the lower chamber to the upper chamber in a controlled manner to facilitate heat transfer;
b) a heat pump operatively associated with the lower chamber of the buffer tank and having an output for heating water in the lower chamber of the buffer tank to a temperature within a predefined temperature range; and
c) an auxiliary heat source operatively associated with the upper chamber of the buffer tank and having an output for increasing the temperature of water in the upper chamber of the buffer tank to conditionally supplement the output of the heat pump.

2. A hydronic space heating system as recited in claim 1, further comprising at least one emitter for heating an interior space.

3. A hydronic space heating system as recited in claim 2, further comprising an in-line fluid pump for circulating heated water through the system.

4. A hydronic space heating system as recited in claim 3, wherein the in-line fluid pump is located between the buffer tank and the at least one emitter.

5. A hydronic space heating system as recited in claim 1, wherein the lower chamber of the buffer tank is heated by the heat pump to a range of about between 80-140 degrees F.

6. A hydronic space heating system as recited in claim 5, wherein the auxiliary heat source is adapted to increase the temperature of water in the upper chamber of the buffer tank to a temperature of about between 140-180 degrees F.

7. A hydronic space heating system as recited in claim 1, wherein the output of the heat pump is transferred to the lower chamber of the buffer tank by an internal heating coil located within the lower chamber of the buffer tank.

8. A hydronic space heating system as recited in claim 1, wherein the output of the heat pump is transferred to the lower chamber of the buffer tank by an external heating coil wrapped around the lower chamber of the buffer tank.

9. A hydronic space heating system as recited in claim 1, wherein the output of the heat pump is transferred to the lower chamber of the buffer tank by a heat exchanger.

10. A hydronic space heating system as recited in claim 1, wherein the output of the auxiliary heat source is provided by a fuel source.

11. A hydronic space heating system as recited in claim 1, wherein the output of the auxiliary heat source is provided by an electric resistance element.

12. A hydronic space heating system comprising:
a) a buffer tank defining upper and lower chambers in fluid and thermal communication with one another, the upper and lower chambers being separated by a baffle having passages formed therein to allow fluid flow from the lower chamber to the upper chamber in a controlled manner to facilitate heat transfer;
b) an air source heat pump communicating with the lower chamber of the buffer tank and having an output for heating water in the lower chamber of the buffer tank to a temperature within a range of about between 80-140 degrees F.; and
c) an auxiliary heat source communicating with the upper chamber of the buffer tank and having an output for increasing the temperature of water in the upper chamber of the buffer tank within the range of 140-180 degrees F. to conditionally supplement the output of the air source heat pump.

13. A hydronic space heating system as recited in claim 12, further comprising an in-line fluid pump located between the buffer tank and at least one emitter for circulating heated water through the system.

14. A hydronic space heating system as recited in claim 12, wherein the output of the heat pump is transferred to the lower chamber of the buffer tank by an internal heating coil located within the lower chamber of the buffer tank.

15. A hydronic space heating system as recited in claim 12, wherein the output of the heat pump is transferred to the lower chamber of the buffer tank by an external heating coil wrapped around the lower chamber of the buffer tank.

16. A hydronic space heating system as recited in claim 12, wherein the output of the heat pump is transferred to the lower chamber of the buffer tank by a heat exchanger.

17. A hydronic space heating system as recited in claim 12, wherein the output of the auxiliary heat source is provided by a fuel source.

18. A hydronic space heating system as recited in claim 12, wherein the output of the auxiliary heat source is provided by an electric resistance element.
